(19) United States
(12) Patent Application Publication
(10) Pub. No.: US 2025/0100456 A1
(43) Pub. Date: Mar. 27, 2025

(54) METHOD FOR TRIGGERING TRUNK MECHANISM USING COMPUTER VISION

(71) Applicant: Mitsubishi Electric Automotive America, Inc., Mason, OH (US)

(72) Inventors: Matheus F. DE ALMEIDA, Northville, MI (US); Grygorii MAISTRENKO, Northville, MI (US); Sana JAFRI, Northville, MI (US)

(21) Appl. No.: 18/472,872

(22) Filed: Sep. 22, 2023

(51) Int. Cl. B60R 5/04; G06V 20/58; G06V 40/16; G06V 40/20

(52) U.S. Cl. CPC B60R 5/04; G06V 20/58; G06V 40/168; G06V 40/23

(57) ABSTRACT

A method for opening a trunk of a vehicle is provided, comprising: receiving sensor data from at least one of a plurality of sensors mounted on the vehicle; determining that a person is present within a predetermined distance of the vehicle based on the sensor data; determining that the person is a registered user of the vehicle based on the sensor data and stored user data; determining that the person performs an acceptable combination of actions; and responsive to determining that the person performs the acceptable combination of actions, controlling a trunk door actuator to open the trunk of the vehicle. The acceptable combination of actions includes at least two of the following actions: approaching the vehicle, performing a predetermined facial gesture, performing a predetermined body gesture, and performing a predetermined voice command.

### TECHNICAL FIELD

The disclosed systems and methods relate generally to systems for automatically opening vehicle trunks. More particularly, the disclosed systems and methods relate to vehicle systems that use sensors to determine actions or voice commands of a user near the vehicle and open the trunk in response to determining that the user performs an acceptable combination of actions.

### BACKGROUND

Systems for opening a trunk of a vehicle are provided to automatically open a trunk of a vehicle so that a user does not need to physically open the trunk door.

Various systems for automatically opening a trunk of a vehicle exist. However, they may require a user to get close to the vehicle, perform an action and/or make contact with the vehicle, and then move back to avoid being hit by the trunk door as it opens. Some existing systems require a user to stand on one leg to perform an action to trigger the trunk to open, which is difficult or impossible for many users. As such, is desirable to provide a system that can authorize a user to open the trunk from a distance and begin opening the trunk while the user is still approaching the vehicle.

Furthermore, when a user opens the trunk, they will often be carrying items that they wish to place into the trunk. Therefore, it is also desirable to provide an automatic trunk opening system that can be used in a hands-free manner.

### SUMMARY OF THE INVENTION

According to one or more embodiments, a method for opening a trunk of a vehicle is provided, comprising: receiving sensor data from at least one of a plurality of sensors mounted on the vehicle; determining that a person is present within a predetermined distance of the vehicle based on the sensor data; responsive to determining that the person is present within the predetermined distance of the vehicle, determining that the person is a registered user of the vehicle based on the sensor data and stored user data; responsive to determining that the person is the registered user of the vehicle, determining that the person performs an acceptable combination of actions; and responsive to determining that the person performs the acceptable combination of actions, controlling a trunk door actuator to open the trunk of the vehicle, wherein the acceptable combination of actions includes at least two of the following actions: approaching the vehicle, performing a predetermined facial gesture, performing a predetermined body gesture, and performing a predetermined voice command.

Responsive to determining that the person is the registered user, the method may further comprise retrieving a stored user profile associated with the person, wherein the stored user profile indicates at least one predetermined combination of actions associated with the person that satisfies the requirement of the acceptable combination of actions.

The stored user profile may further include at least one of facial data of the registered user or voice data of the registered user.

The acceptable combination of actions may vary such that any combination of two or more of approaching the vehicle, performing a predetermined facial gesture, performing a predetermined body gesture, and performing a predetermined voice command can constitute the acceptable combination.

The plurality of sensors mounted on the vehicle may include at least one of a microphone, a camera, a radar sensor, a sonar sensor, or a LiDAR sensor.

The method for opening the trunk of the vehicle may further comprise identifying at least one facial landmark on a face of the person, wherein determining that the person performs the predetermined combination of actions comprises tracking the at least one facial landmark and identifying whether the at least one facial landmark makes at least one of a predetermined one or more acceptable facial movements.

The at least one facial landmark may include a nose of the person, an eye of the person, lips of the person, or an eyebrow of the person.

The method for opening the trunk of the vehicle may further comprise identifying at least one body landmark on a body of the person, wherein determining that the person performs the predetermined combination of actions comprises tracking the at least one body landmark and identifying whether the at least one body landmark makes at least one of a predetermined one or more acceptable body movements.

The at least one body landmark may include a hand of the person, a foot of the person, a knee of the person, an elbow of the person, a head of the person, or an abdomen of the person.

The acceptable combination of actions may comprise performing the predetermined facial gesture.

The acceptable combination of actions may comprise performing the predetermined voice command.

The acceptable combination of actions may comprise approaching the vehicle.

The acceptable combination of actions may comprise performing the predetermined body gesture.

Responsive to determining that the person is present within the predetermined distance of the vehicle, the method for opening the trunk of the vehicle may further comprise determining whether the person is approaching the vehicle based on the sensor data.

The operation of determining that the person is the registered user of the vehicle based on the received data may comprise: analyzing the sensor data to identify a face of the person, comparing the identified face of the person to stored image data of the face of the registered user, and determining that the person is the registered user responsive to the identified face of the person matching the stored image data of the face of the registered user.

The received data may include audio data, and the operation of determining that the person is the registered user of the vehicle based on the received data may comprise analyzing the audio data to identify voice data corresponding to a voice of the person, comparing the identified voice data to stored voice data corresponding to a voice of the registered user, and determining that the person is the registered user responsive to the identified voice data matching the stored voice data of the registered user.

The operation of determining that a person is present within a predetermined distance of the vehicle based on the received data may comprise locating a face of the person, identifying a distance of the person from the vehicle, and determining that the distance from the person to the vehicle is within the predetermined distance.

The predetermined distance may be 5 meters.

The predetermined distance may be 3 meters.

According to one or more embodiments, an alternative method for opening a trunk of a vehicle is provided, comprising: receiving sensor data from at least one of a plurality of sensors mounted on the vehicle; determining that a person is present within a predetermined distance of the vehicle based on the sensor data; responsive to determining that the person is present within the predetermined distance of the vehicle, determining that the person is a registered user of the vehicle based on the sensor data; responsive to determining that the person is the registered user of the vehicle, determining that the person is approaching the vehicle based on the sensor data; responsive to determining that the person is approaching the vehicle, determining that the person performs a predetermined action; and responsive to determining that the person performs the predetermined action, controlling a trunk door actuator to open the trunk of the vehicle, wherein the predetermined action includes at least one of performing a predetermined facial gesture, performing a predetermined body gesture, or performing a predetermined voice command.

Responsive to determining that the person is the registered user, the method for opening the trunk of the vehicle may further comprise retrieving a stored user profile associated with the person, wherein the stored user profile indicates at least one predetermined action associated with the person.

The stored user profile may include at least one of facial data of the registered user or voice data of the registered user.

The plurality of sensors mounted on the vehicle may include at least one of a microphone, a camera, a radar sensor, a sonar sensor, or a LiDAR sensor.

The method for opening the trunk of the vehicle may further comprise identifying at least one facial landmark on a face of the person, wherein determining that the person performs the predetermined action comprises tracking the at least one facial landmark; and identifying whether the at least one facial landmark makes at least one of a predetermined one or more acceptable facial movements.

The at least one facial landmark may include a nose of the person, an eye of the person, lips of the person, or an eyebrow of the person.

The method for opening the trunk of the vehicle may further comprise identifying at least one body landmark on a body of the person, wherein determining that the person performs the predetermined action comprises tracking the at least one body landmark; and identifying whether the at least one body landmark makes at least one of a predetermined one or more acceptable body movements.

The at least one body landmark may include a hand of the person, a foot of the person, a knee of the person, an elbow of the person, a head of the person, or an abdomen of the person.

The predetermined action may comprise performing the predetermined facial gesture.

The predetermined action may comprise performing the predetermined voice command.

The predetermined action may comprise performing the predetermined body gesture.

The operation of determining that the person is the registered user of the vehicle based on the received data may comprise: analyzing the sensor data to identify a face of the person,

comparing the identified face of the person to stored image data of the face of the registered user, and determining that the person is the registered user responsive to the identified face of the person matching the stored image data of the face of the registered user.

The received data may include audio data, and the operation of determining that the person is the registered user of the vehicle based on the received data may comprise analyzing the audio data to identify voice data corresponding to a voice of the person, comparing the identified voice data to stored voice data corresponding to a voice of the registered user, and determining that the person is the registered user responsive to the identified voice data matching the stored voice data of the registered user.

The operation of determining that a person is present within a predetermined distance of the vehicle based on the received data may comprise locating a face of the person, identifying a distance of the person from the vehicle, and determining that the distance from the person to the vehicle is within the predetermined distance.

The predetermined distance may be 5 meters.

The predetermined distance may be 3 meters.

According to one or more embodiments, a method for controlling a trunk door of a vehicle is provided, comprising: receiving sensor data from at least one of a plurality of sensors mounted on the vehicle; determining that a person is present within a predetermined distance of the vehicle based on the sensor data; responsive to determining that the person is present within the predetermined distance of the vehicle, determining that the person is a registered user of the vehicle based on the sensor data and stored user data; responsive to determining that the person is the registered user of the vehicle, determining that the person is moving away from the vehicle; and responsive to determining that the person is moving away from the vehicle, controlling the trunk door actuator so that the trunk door is not opened.

The plurality of sensors mounted on the vehicle includes at least one of a microphone, a camera, a radar sensor, a sonar sensor, or a LiDAR sensor.

The operation of determining that the person is the registered user of the vehicle based on the received data may further comprise: analyzing the sensor data to identify a face of the person,

comparing the identified face of the person to stored image data of the face of the registered user, and determining that the person is the registered user responsive to the identified face of the person matching the stored image data of the face of the registered user.

The received data may include audio data, and the operation of determining that the person is the registered user of the vehicle based on the received data may comprise analyzing the audio data to identify voice data corresponding to a voice of the person, comparing the identified voice data to stored voice data corresponding to a voice of the registered user, and determining that the person is the registered user responsive to the identified voice data matching the stored voice data of the registered user.

The operation of determining that a person is present within a predetermined distance of the vehicle based on the received data may comprise locating a face of the person, identifying a distance of the person from the vehicle, and determining that the distance from the person to the vehicle is within the predetermined distance.

The predetermined distance may be 5 meters.

The predetermined distance may be 3 meters.

A non-transitory computer-readable medium is provided including instructions for execution by a computer, the instructions including a computer-implemented method for mitigating driver distraction in a vehicle, the instructions for implementing: receiving sensor data from at least one of a plurality of sensors mounted on the vehicle; determining that a person is present within a predetermined distance of the vehicle based on the sensor data; responsive to determining that the person is present within the predetermined distance of the vehicle, determining that the person is a registered user of the vehicle based on the sensor data and stored user data; responsive to determining that the person is the registered user of the vehicle, determining that the person performs an acceptable combination of actions; and responsive to determining that the person performs the acceptable combination of actions, controlling a trunk door actuator to open the trunk of the vehicle, wherein the acceptable combination of actions includes at least two of the following actions: approaching the vehicle, performing a predetermined facial gesture, performing a predetermined body gesture, and performing a predetermined voice command.

The instructions may be for further implementing: responsive to determining that the person is the registered user, retrieving a stored user profile associated with the person, wherein the stored user profile indicates at least one predetermined combination of actions associated with the person that satisfy the requirement of the acceptable combination of actions.

The acceptable combination of actions can vary such that any combination of two or more of approaching the vehicle, performing a predetermined facial gesture, performing a predetermined body gesture, and performing a predetermined voice command can constitute the acceptable combination.

The instructions may be for further implementing: identifying at least one facial landmark on a face of the person, wherein determining that the person performs the predetermined combination of actions comprises tracking the at least one facial landmark; and identifying whether the at least one facial landmark makes at least one of a predetermined one or more acceptable facial movements.

The instructions may be for further implementing: identifying at least one body landmark on a body of the person, wherein determining that the person performs the predetermined combination of actions comprises tracking the at least one body landmark; and identifying whether the at least one body landmark makes at least one of a predetermined one or more acceptable body movements.

The instructions may be for further implementing: responsive to determining that the person is present within the predetermined distance of the vehicle, determining whether the person is approaching the vehicle based on the sensor data.

The operation of determining that the person is the registered user of the vehicle based on the received data may further comprise: analyzing the sensor data to identify a face of the person, comparing the identified face of the person to stored image data of the face of the registered user, and determining that the person is the registered user responsive to the identified face of the person matching the stored image data of the face of the registered user.

The received data may include audio data, and the operation of determining that the person is the registered user of the vehicle based on the received data may comprise analyzing the audio data to identify voice data corresponding to a voice of the person, comparing the identified voice data to stored voice data corresponding to a voice of the registered user, and determining that the person is the registered user responsive to the identified voice data matching the stored voice data of the registered user.

The operation of determining that a person is present within a predetermined distance of the vehicle based on the received data may comprise locating a face of the person, identifying a distance of the person from the vehicle, and determining that the distance from the person to the vehicle is within the predetermined distance.

The predetermined action may include at least one of performing a predetermined facial gesture, performing a predetermined body gesture, or performing a predetermined voice command.

A computer system is provided configured for controlling an operational mode of an outdoor air-conditioning unit connected to a plurality of indoor air-conditioning units, the plurality of indoor air-conditioning units including a master indoor unit and a plurality of reporting indoor units, the system including: a transceiver operable to transmit and receive communications over at least a portion of a network; a memory configured to store data and instructions; and a processor cooperatively operable with the transceiver and the memory, and configured to facilitate: receiving sensor data from at least one of a plurality of sensors mounted on the vehicle; determining that a person is present within a predetermined distance of the vehicle based on the sensor data; responsive to determining that the person is present within the predetermined distance of the vehicle, determining that the person is a registered user of the vehicle based on the sensor data and stored user data; responsive to determining that the person is the registered user of the vehicle, determining that the person performs an acceptable combination of actions; and responsive to determining that the person performs the acceptable combination of actions, controlling a trunk door actuator to open the trunk of the vehicle, wherein the acceptable combination of actions includes at least two of the following actions: approaching the vehicle, performing a predetermined facial gesture, performing a predetermined body gesture, and performing a predetermined voice command.

The processor may be further configured to facilitate: responsive to determining that the person is the registered user, retrieving a stored user profile associated with the person, wherein the stored user profile indicates at least one predetermined combination of actions associated with the person that satisfy the requirement of the acceptable combination of actions.

The acceptable combination of actions can vary such that any combination of two or more of approaching the vehicle, performing a predetermined facial gesture, performing a predetermined body gesture, and performing a predetermined voice command can constitute the acceptable combination.

The processor may be further configured to facilitate: identifying at least one facial landmark on a face of the person, wherein determining that the person performs the predetermined combination of actions comprises tracking the at least one facial landmark; and identifying whether the at least one facial landmark makes at least one of a predetermined one or more acceptable facial movements.

The processor may be further configured to facilitate: identifying at least one body landmark on a body of the person, wherein determining that the person performs the predetermined combination of actions comprises tracking the at least one body landmark; and identifying whether the at least one body landmark makes at least one of a predetermined one or more acceptable body movements.

The processor may be further configured to facilitate: responsive to determining that the person is present within the predetermined distance of the vehicle, determining whether the person is approaching the vehicle based on the sensor data.

The operation of determining that the person is the registered user of the vehicle based on the received data may further comprise: analyzing the sensor data to identify a face of the person, comparing the identified face of the person to stored image data of the face of the registered user, and determining that the person is the registered user responsive to the identified face of the person matching the stored image data of the face of the registered user.

The received data may include audio data, and the operation of determining that the person is the registered user of the vehicle based on the received data may include analyzing the audio data to identify voice data corresponding to a voice of the person, comparing the identified voice data to stored voice data corresponding to a voice of the registered user, and determining that the person is the registered user responsive to the identified voice data matching the stored voice data of the registered user.

The operation of determining that a person is present within a predetermined distance of the vehicle based on the received data may include locating a face of the person, identifying a distance of the person from the vehicle, and determining that the distance from the person to the vehicle is within the predetermined distance.

The predetermined action may include at least one of performing a predetermined facial gesture, performing a predetermined body gesture, or performing a predetermined voice command.

### BRIEF DESCRIPTION OF THE DRAWINGS

The accompanying figures, where like reference numerals refer to identical or functionally similar elements and which together with the detailed description below are incorporated in and form part of the specification, serve to further illustrate an exemplary embodiment and to explain various principles and advantages in accordance with the present disclosure.

FIG. 1 is a diagram of a vehicle environment according to disclosed embodiments;

FIG. 2 is a block diagram of a vehicle system according to disclosed embodiments;

FIG. 3 is a block diagram of a vehicle controller according to disclosed embodiments;

FIG. 4 is a diagram of a controller memory according to disclosed embodiments;

FIG. 5 is a flow chart of an operation of a vehicle trunk actuation system according to disclosed embodiments;

FIG. 6 is a flow chart of an operation of identifying a registered user according to disclosed embodiments;

FIG. 7 is a flow chart of an operation of determining whether a voice command has been received according to disclosed embodiments;

FIG. 8 is a flow chart of an operation of determining whether a person has made a command with head or facial movements according to disclosed embodiments;

FIG. 9 is a flow chart of an operation of determining whether a person has made a command with body movements according to disclosed embodiments; and

FIG. 10 is a flow chart of an operation of a vehicle trunk actuation system according to an alternate embodiment.

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, may be supported with or in integrated circuits (ICs), such as dynamic random access memory (DRAM) devices, static random access memory (SRAM) devices, or the like. In particular, they may be implemented using CMOS transistors. It is expected that one of ordinary skill, notwithstanding possibly significant effort and many design choices motivated by, for example, available time, current technology, and economic considerations, when guided by the concepts and principles disclosed herein will be readily capable of generating such ICs with minimal experimentation. Therefore, in the interest of brevity and minimization of any risk of obscuring the principles and concepts according to the present invention, further discussion of such ICs will be limited to the essentials with respect to the principles and concepts used by the exemplary embodiments.

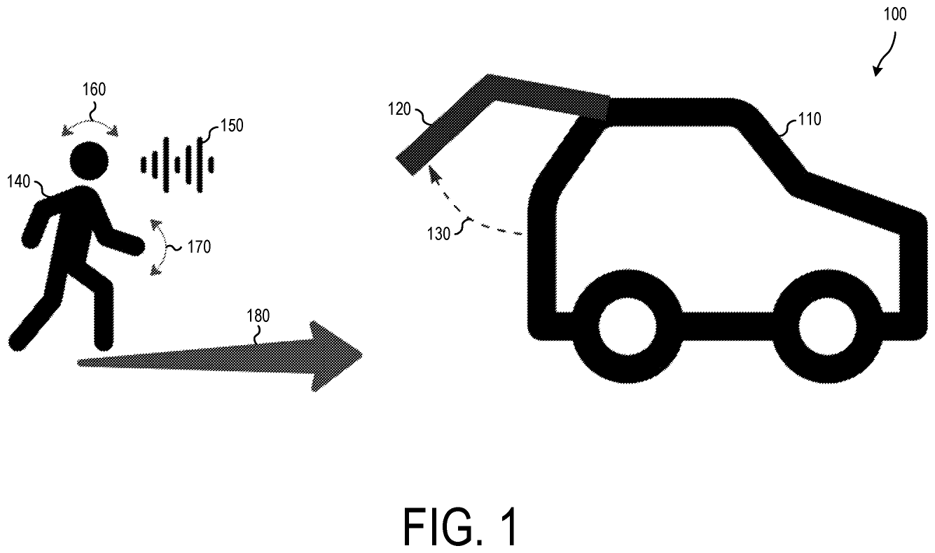

FIG. 1 is a diagram of a vehicle environment 100 according to disclosed embodiments. As shown in FIG. 1, the vehicle environment includes a vehicle 110 and a person 140. The vehicle includes a trunk door 120 that is configured to open 130. The person 140 can perform a number of actions including speaking (i.e., making a voice command) 150, making a facial gesture 160, making a body gesture 170, and approaching the vehicle 110.

While proximate to the vehicle 110, the person 140 may perform an acceptable combination of actions to command the vehicle 110 to open 130 the trunk door 120 automatically.

The acceptable combination of actions includes at least two of the following actions: approaching the vehicle 180, performing a predetermined facial gesture 160, performing a predetermined body gesture 170, and performing a predetermined voice command 150.

In this manner, a person 140 who is identified by systems in the vehicle 110 as a registered user of the vehicle 110 can cause the trunk door 120 to open while the person 140 is still approaching the vehicle 110. As such, the person 140 does not have to arrive at the vehicle 110 and then step back to avoid the trunk door 120 as it opens. Furthermore, the user may command the vehicle 110 to open the trunk door 120 even if their hands are full or even if they are unable to make voice commands 150 or body gestures 170.

Additionally, the security of the vehicle 110 is improved when the acceptable combination of actions includes at least two predetermined actions. Requiring at least two actions of different types confirms the intention of the person 140 to open the trunk and reduces the chance of the vehicle 110 opening the trunk door 120 automatically when the person 140 does not intend to open the trunk door 120.

Although the following description refers to methods for automatically opening a trunk (i.e., a rear door of the vehicle), it can be applied to a method of automatically opening any door in a vehicle. Some embodiments will allow for multiple doors on a single vehicle to be opened automatically using the methods described below.

### Vehicle System

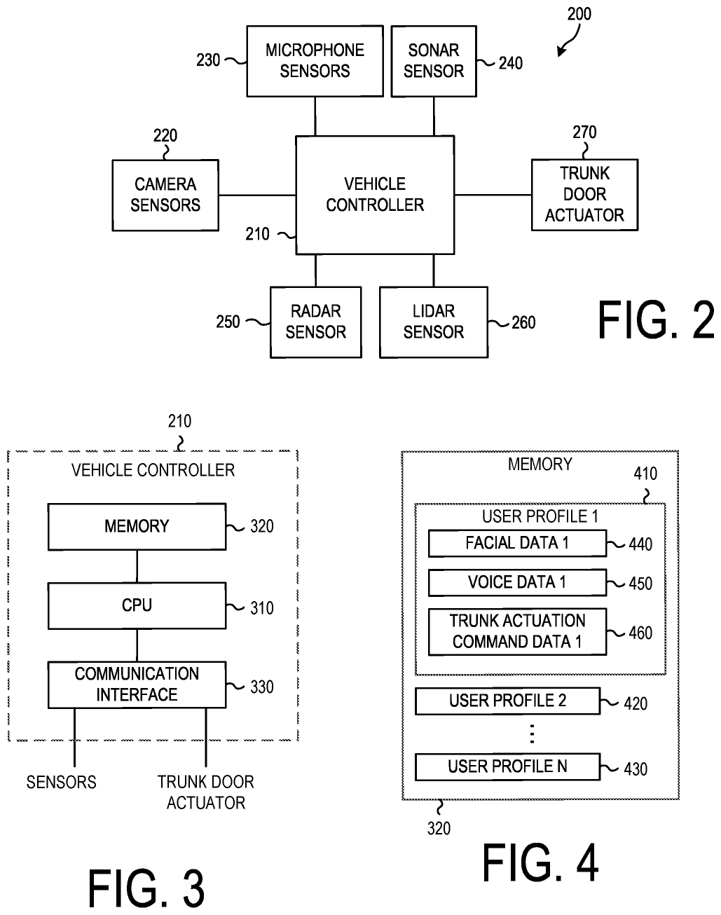

FIG. 2 is a block diagram of a vehicle system 200 according to disclosed embodiments. As shown in FIG. 2, the vehicle system 200 includes a vehicle controller 210, one or more camera sensors 220, one or more microphone sensors 230, one or more sonar sensors 240, one or more radar sensors 250, one or more light detection and ranging (hereinafter, LiDAR) sensors 260, and a trunk door actuator 270.

The vehicle controller 210 is configured to control the operation of the vehicle system 200. It receives data from and provides control signals to the one or more camera sensors 220, the one or more microphone sensors 230, the one or more sonar sensors 240, the one or more radar sensors 250, the one or more LiDAR sensors 260, and the trunk door actuator 270.

The one or more camera sensors 220 are circuits that use video sensors along a variety of spectrums. They can include visible-light cameras or infrared cameras. The camera sensors 220 can detect a presence of a person 140 within a predetermined distance from the vehicle 110, locate a face of the person 140 in the vicinity of the vehicle 110, detect and track facial landmarks of the person 140, detect and track body landmarks of the person 140, or the like. The one or more camera sensors 220 may be placed at different locations on the interior or the exterior of the vehicle 110. At least one of the camera sensors 220 may preferably be disposed on an exterior of a rear portion of the vehicle 110. Alternate embodiments may omit the one or more camera sensors.

In addition, alternate embodiments can employ multiple cameras proximate to other doors to enable the opening of those other doors via similar methods. This combination of cameras could monitor a wider range of areas than just the back of the vehicle. For example, instead of or in addition to facilitating the opening of a trunk, the disclosed methods could be used to open a side door. This could be very helpful for a disabled person who may find it easier to perform voice or facial gestures than to physically open the door.

The one or more microphone sensors 230 are circuits that detect sound and allow the controller 210 to use that sound for a variety of purposes including voice recognition and recognition of vocal commands 150. The one or more microphone sensors 230 may be placed at different locations on the interior or the exterior of the vehicle 110. At least one of the microphone sensors 230 may preferably be disposed on an exterior of a rear portion of the vehicle 110. Alternate embodiments may omit the one or more microphone sensors. Alternate embodiments with more than one camera can have a microphone associated with each camera or wider-range microphones that cover the area around each door that can be automatically opened, i.e., the same area covered by the plurality of cameras.

The one or more sonar sensors 240 are circuits that use sonar to detect a variety of parameters. The one or more sonar sensors 240 may detect a presence of a person 140 within a predetermined distance from the vehicle 110, locate a face of the person 140 in the vicinity of the vehicle 110, detect and track facial landmarks of the person 140, detect and track body landmarks of the person 140, detect the direction of motion for the person 140, or the like. Alternate embodiments may omit the one or more sonar sensors.

The one or more radar sensors 250 are circuits that use radar to detect a variety of parameters. The one or more radar sensors 250 may detect a presence of a person 140 within a predetermined distance from the vehicle 110, locate a face of the person 140 in the vicinity of the vehicle 110, detect and track facial landmarks of the person 140, detect and track body landmarks of the person 140, detect the direction of motion for the person 140, or the like. Alternate embodiments may omit the one or more radar sensors.

The one or more LiDAR sensors 260 are circuits that use light detection and ranging to detect a variety of parameters. The one or more LiDAR sensors 260 may detect a presence of a person 140 within a predetermined distance from the vehicle 110, locate a face of the person 140 in the vicinity of the vehicle 110, detect and track facial landmarks of the person 140, detect and track body landmarks of the person 140, detect the direction of motion for the person 140, or the like. Alternate embodiments may omit the one or more LiDAR sensors.

The trunk door actuator 270 is an actuator configured to open and close a trunk door 120. The trunk door actuator 270 may comprise one or more motors, one or more linear actuators, one or more springs, one or more hydraulic actuators, a combination thereof, or the like. The trunk door actuator 270 operates according to signals received from the vehicle controller 210.

FIG. 3 is a block diagram of the vehicle controller 210 of FIG. 2 according to disclosed embodiments. As shown in FIG. 3, the vehicle controller 210 can include a memory 320, a processor 310, and a communication interface 330.

The processor 310 receives signals from and generates signals to control the one or more camera sensors 220, the one or more microphone sensors 230, the one or more sonar sensors 240, the one or more radar sensors 250, the one or more LiDAR sensors 260, and the trunk door actuator 270. The processor 310 can be a can be a microprocessor (e.g., a central processing unit), an application-specific integrated circuit (ASIC), or any suitable device for controlling the operation of all or part of the vehicle system 200.

The memory 320 is configured to store information and operation programs. The memory 320 can include a read-only memory (ROM), a random-access memory (RAM), an electronically programmable read-only memory (EPROM), an electrically erasable programmable read only memory (EEPROM), flash memory, or any suitable memory device.

The communication interface 330 is configured to transmit and receive communications over at least a portion of the vehicle system 200. In particular, the communication interface 330 has a communication connection to at least the one or more camera sensors 220, the one or more microphone sensors 230, the one or more sonar sensors 240, the one or more radar sensors 250, the one or more LiDAR sensors 260, and the trunk door actuator 270. Although the communication interface 330 is only shown in FIG. 3 as having signal lines connecting it to the sensors 220, 230, 240, 250, and 260 and the trunk door actuator 270, this is simply for ease of disclosure. The communication interface 330 would also have a communication connection to any element in the vehicle system 200 that requires instructions from the controller 210 or provides data to the controller 210.

The connection implemented by the communication interface 330 could be wired or wireless between the communications interface 330 and any element in the vehicle system 200 in various embodiments. In some embodiments the connections can be a mix of wired and wireless connections.

FIG. 4 is a diagram of a controller memory 320 according to disclosed embodiments. As shown in FIG. 4, the controller memory 320 stores one or more user profiles 410, 420, 430. Each of the user profiles 410, 420, 430 is associated with a registered user of the vehicle 110 and contains data associated with the registered user. There may be only a single registered user of the vehicle 110, and thus only one corresponding user profile 410 may be stored in the memory 320. Alternatively, there may be multiple registered users of the vehicle 110 and multiple corresponding user profiles 410, 420, 430 may be stored in the memory 320. There is no limit to the number of registered users of the vehicle 110. For ease of disclosure, FIG. 4 illustrates three user profiles 410, 420, 430 stored in the memory 320.

Each user profile 410, 420, 430 stored in the memory 320 may include some or all of facial data 440, voice data 450, and trunk actuation command data 460 associated with the registered user corresponding to the user profile 410, 420, 430.

For example, the user profile 410 associated with a first registered user of the vehicle 110 stores facial data 440 of the first registered user. The facial data 440 may include stored data acquired from the one or more camera sensors 220, the one or more sonar sensors 240, the one or more radar sensors 250, and/or the one or more LiDAR sensors 260. The facial data 440 of the first registered user may include image data that has been provided to the vehicle controller 210 by the first registered user.

The user profile 410 of the first registered user may contain voice data 450 of the first registered user. The voice data 450 may include stored data acquired from the one or more microphone sensors 230. The voice data 450 may include audio data that has been provided to the vehicle controller 210 by the first registered user or, in some embodiments, by any registered user.

The user profile 410 of the first registered user may include trunk actuation command data 460 associated with the first registered user. The trunk actuation command data 460 indicates at least one acceptable combination of actions for the first registered user to command the vehicle 110 to open the trunk door 120.

Each of the at least one acceptable combination of actions indicated by the trunk actuation command data 460 includes at least two of the following categories of actions: a voice command 150, a facial gesture 160, a body gesture 170, or approaching the vehicle 180.

A voice command 150 may comprise the registered user saying a predetermined word, a predetermined combination of words, making a sound, making a predetermined combination of sounds, or making a predetermined combination of words and sounds.

A facial gesture 160 may include, for example, blinking the eyes a predetermined number of times, holding a blink for a predetermined length of time, winking a particular eye, raising the eyebrows a predetermined number of times, raising a particular eyebrow, opening and closing the mouth a predetermined number of times, holding the mouth open for a predetermined amount of time, making a smile, making a frown, nodding the head a predetermined number of times, turning the head in a particular direction, or another movement of the face or head.

A body gesture 170 may include, for example, raising a hand, waving a hand a predetermined number of times, raising a foot, stomping a foot a predetermined number of times, raising a particular finger or a particular number of fingers, raising a knee, raising an elbow, turning around in a circle, or another movement of the body.

Approaching the vehicle 180 comprises the registered user moving toward the vehicle such that the distance between the user and the vehicle becomes smaller. This may include walking or running toward the vehicle, moving toward the vehicle in a wheelchair, or another method of moving toward the vehicle.

### Operation of the Vehicle System

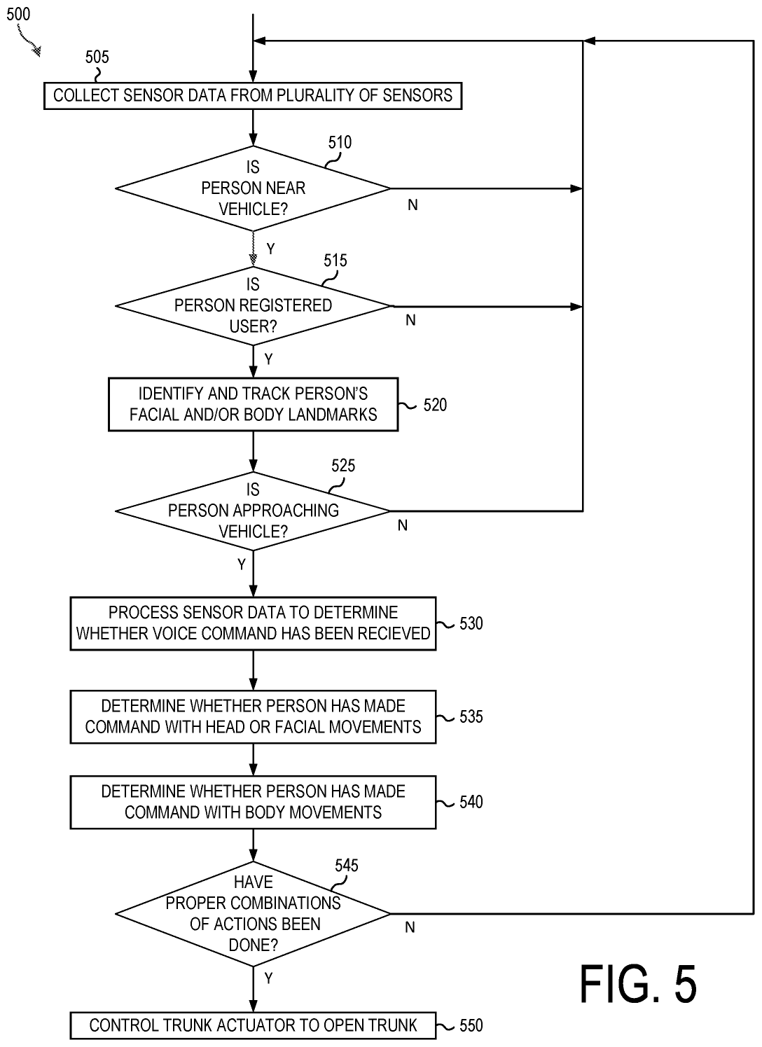

FIG. 5 is a flow chart showing an operation 500 of the vehicle system 200 according to disclosed embodiments.

As shown in FIG. 5, the operation 500 begins with collecting sensor data from a plurality of sensors. (505) The plurality of sensors may include at least one of the one or more camera sensors 220, the one or more microphone sensors 230, the one or more sonar sensors 240, the one or more radar sensors 250, and the one or more LiDAR sensors 260. The collected sensor data may be communicated to the controller 210 via the communication interface 330. The plurality of sensors may continue to collect data and communicate it to the controller 210 throughout the operation 500.

The controller 210 analyzes the collected data from the plurality of sensors to determine whether a person 140 is near the vehicle 110. (510) The controller 210 may determine whether a person 140 is present within a predetermined distance of the vehicle 110. The predetermined distance may be, for example, 2 meters, 3 meters, or 5 meters.

To determine whether the person 140 is present within the predetermined distance of the vehicle 110 based on the received data, the controller 210 may analyze the collected data to perform real-time face detection to locate a face of the person 140. The controller may identify a distance of the person 140 from the vehicle 110 based on the detected location of the face of the person 140 and determine whether the distance from the person 140 to the vehicle 110 is within the predetermined distance.

When the controller 210 determines that the person 140 is not within the predetermined distance from the vehicle 110, the controller 210 returns to collecting sensor data from the plurality of sensors. (505)

When the controller 210 determines that the person 140 is within the predetermined distance from the vehicle 110, the controller 210 determines whether the person 140 is a registered user of the vehicle 110 based on the collected data from the plurality of sensors. (515) The controller 210 may compare the collected sensor data to data stored in the memory 320 to determine whether the person 140 is a registered user.

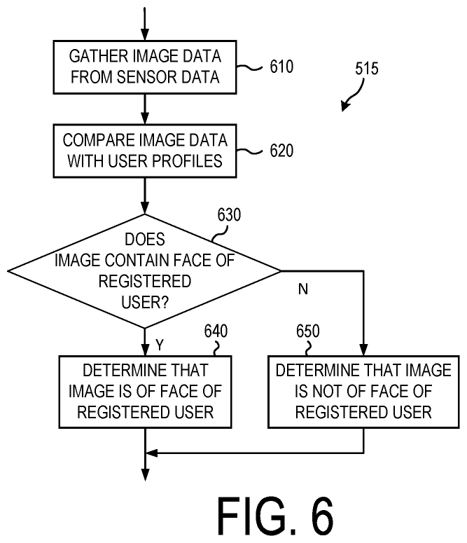

In particular, the controller 210 may compare the data collected from the plurality of sensors to data stored in user profiles 410, 420, 430. Each user profile 410, 420, 430 is associated with a different registered user of the vehicle 110. The data stored in each of the user profiles 410, 420, 430 may include, for example, facial data 440 of a registered user, voice data 450 of a registered user, or a combination of facial data 440 and voice data 450 of the registered user. An exemplary method of determining whether the person 140 is a registered user of the vehicle 110 is discussed below with respect to FIG. 6.

When the controller 210 determines that the person 140 is not a registered user, the controller 210 returns to collecting sensor data from the plurality of sensors. (505)

When the controller 210 determines that the person 140 is a registered user, the controller 210 controls at least one of the plurality of sensors to identify and track at least one facial landmark or at least one body landmark of the person 140. (520) The at least one sensor of the plurality of sensors may include at least one of the one or more camera sensors 220, the one or more microphone sensors 230, the one or more sonar sensors 240, the one or more radar sensors 250, or the one or more LiDAR sensors 260.

The body landmark may include a hand of the person 140, a foot of the person 140, a knee of the person 140, an elbow of the person 140, a head of the person 140, or an abdomen of the person 140. The facial landmark may include a nose of the person 140, an eye of the person 140, lips of the person 140, or an eyebrow of the person 140.

The controller 210 processes the data collected by the plurality of sensors to determine whether the person 140 is approaching the vehicle 110. (525) For example, the controller 210 may analyze data from at least one of the one or more camera sensors 220, the one or more sonar sensors 240, the one or more radar sensors 250, or the one or more LiDAR sensors 260 to determine if the person 140 is moving closer to the vehicle 110.

If the controller 210 determines that the person 140 is not approaching the vehicle 110, it is assumed that the person 140 does not want to open the trunk at this time. The operation of the vehicle system 200 returns to collecting sensor data from the plurality of sensors. (505) Therefore, the controller 210 controls the trunk door actuator 270 not to open the trunk door 120. This reduces the risk of opening the trunk door 120 when the person 140 does not intend to do so, improving the security of the vehicle 110.

The person 140 may unintentionally make gestures and/or say words that comprise the acceptable combination of actions that trigger the vehicle 110 to operate the trunk door actuator 270 to open the trunk door 120 while walking away from the vehicle 110 or standing near the vehicle 110. For example, the person 140 may wave their hand, make a particular, facial expression, or say a word that is a voice command while in conversation with another person. It is desirable to prevent the trunk door 120 from being automatically opened in such circumstances when the person 140 is not approaching the vehicle 110 and likely does not want the trunk door 120 to be opened.

If the trunk door 120 is opened when the person 140 does not intend for the truck door 120 to be opened, the person 140 may be inconvenienced because they must shut the trunk door 120 afterward. Furthermore, if the person 140 does not notice that the trunk door 120 has opened, they may leave the trunk door 120 open. This increases the risk of theft and weather damage to the interior of the vehicle 110. Therefore, detecting that the person 140 is approaching the vehicle 110 confirms that the intent of the person 140 is to open the trunk door 120 and increases the security of the vehicle 110.

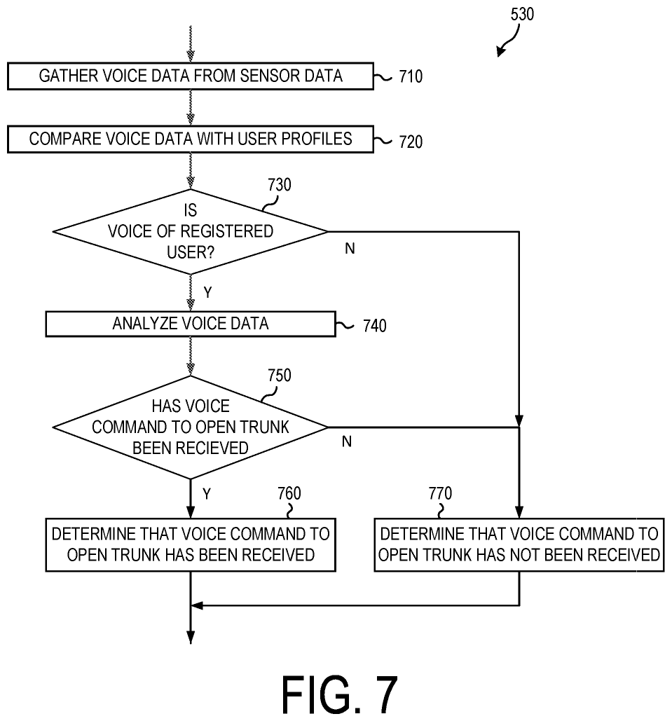

The controller 210 further processes data collected by the plurality of sensors to determine whether a voice command 150 has been received. For example, the controller 210 may process data from the one or more microphone sensors 230 to determine whether the person 140 says one or more words, makes one or more sounds, or makes a combination of sounds and words. (530) An exemplary method of determining whether a voice command 150 is received is discussed below with respect to FIG. 7.

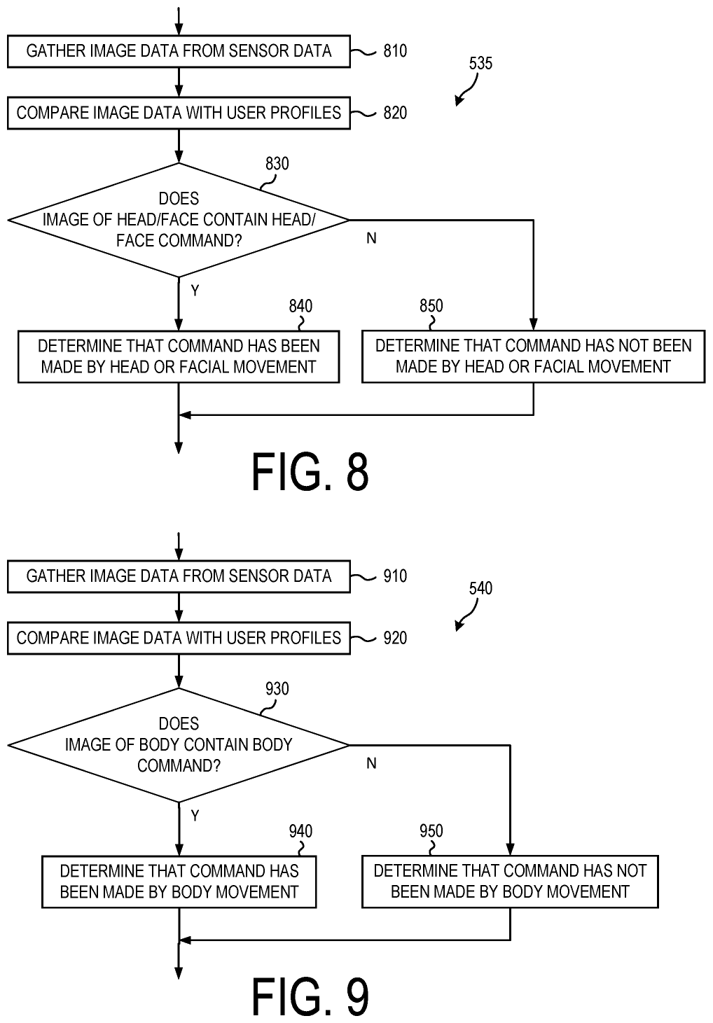

The controller 210 processes data from the plurality of sensors to determine whether the person 140 makes a facial gesture 160. (535) For example, the controller 210 may analyze data from at least one of the one or more camera sensors 220, the one or more sonar sensors 240, the one or more radar sensors 250, or the one or more LiDAR sensors 260 to determine whether the person 140 makes a gesture with their face or head. The controller 210 may process collected data regarding the at least one tracked facial landmark of the person 140 to determine whether the at least one tracked facial landmark makes at least one predetermined acceptable facial gesture 160. An exemplary method of determining whether the person 140 makes a facial gesture 160 is further discussed below with respect to FIG. 8.

The controller 210 processes data to determine whether the person 140 makes a command with a body gesture 170. (540) For example, the controller 210 may analyze data from at least one of the one or more camera sensors 220, the one or more sonar sensors 240, the one or more radar sensors 250, or the one or more LiDAR sensors 260 to determine whether the person 140 makes a body gesture 170. The controller 210 may process collected data regarding the at least one tracked body landmark of the person 140 to determine whether the at least one tracked body landmark makes at least one of a predetermined one or more acceptable body gestures 170. An exemplary method of determining whether the person 140 makes a body gesture 170 is further discussed below with respect to FIG. 9.

The controller 210 determines whether the person 140 has performed an acceptable combination of actions to indicate that the trunk door 120 should be opened. (545)

The acceptable combination of actions includes at least two of the following categories of actions: performing a facial gesture 160, performing a body gesture 170, performing a voice command 150, or approaching the vehicle 180. For example, the acceptable combination of actions may include performing a particular facial gesture 160 and performing a particular voice command 150. The acceptable combination of actions may include performing a particular body gesture 170 and performing a particular facial gesture 160. The acceptable combination of actions may include performing a particular voice command 150 and performing a particular body gesture 170. The acceptable combination of actions may include approaching the vehicle 180 and performing a particular body gesture 170. The acceptable combination of actions may include approaching the vehicle 180 and performing a particular facial gesture 160. The acceptable combination of actions may include approaching the vehicle 180 and performing a particular voice command 150. The acceptable combination of actions may also include performing two or more actions from the same category of action and at least one action from a different category of action. For example, the acceptable combination of actions may include performing two different particular facial gestures 160 and performing a particular voice command 150.

The acceptable combination of actions may include performing an action from each of three of the four categories of actions. For example, the acceptable combination of actions may include performing a body gesture 170, performing a particular facial gesture 160, and performing a particular voice command 150. The acceptable combination of actions may include performing a particular facial gesture 160, performing a particular voice command 150, and approaching the vehicle 180. The acceptable combination of actions may include performing a particular body gesture 170, performing a particular voice command 150, and approaching the vehicle 180. The acceptable combination of actions may include performing a particular facial gesture 160, performing a particular body gesture 170, and approaching the vehicle 180. The acceptable combination of actions may include performing an action from each of the four categories of actions.

The acceptable combination of actions may be required to be performed in a particular sequential order. In this case, the controller 210 processes the data from the plurality of sensors to determine whether proper actions are performed and whether the actions are performed in the proper order.

According to some embodiments, responsive to determining that the person 140 is the registered user, the controller 210 may retrieve the stored user profile 410, 420, 430 associated with the person 140. The stored user profile 410, 420, 430 may contain trunk actuation data 460 that indicates at least one predetermined combination of actions associated with the person 140 that satisfies the requirements of the acceptable combination of actions.

Each registered user may set one or more acceptable combinations of actions in their user profile 410, 420, 430. The registered user may access their user profile 410, 420, 430 through a user interface and edit the trunk actuation command data 460 to indicate the acceptable combination of actions for the particular registered user. For example, a first registered user may set holding a blink for three seconds and raising an elbow as one of the acceptable combinations of actions to be stored in the trunk actuation command data 460 of their user profile 410.

According to some embodiments, each registered user may set one or more predetermined acceptable facial gestures 160, one or more predetermined acceptable body gestures 170, and one or more predetermined acceptable voice commands 150 in the trunk actuation data 460 of their user profile 410, 420, 430. In this case, the acceptable combination of actions for the registered user can vary such that any combination of two or more of approaching the vehicle 180, performing at least one of the one or more predetermined facial gestures 160, performing at least one of the one or more predetermined body gestures 170, or performing at least one of the one or more predetermined voice commands 150 can constitute the acceptable combination of actions. For instance, when the registered user is approaching the vehicle 180 and performing one or more of the predetermined acceptable body gestures 170 stored in the trunk actuation data 460 of their user profile 410, 420, 430, the controller 210 determines that the registered user performs an acceptable combination of actions.

Having a customizable predetermined combination of actions may improve accessibility of the vehicle system 200. For example, if a registered user has difficulty moving their limbs, they may opt to set a voice command 150 and a facial gesture 160 as their acceptable combination of actions. Alternatively, if a registered user has difficulty speaking, they may choose a facial gesture 160 and a body gesture 170 as their predetermined combination of actions. Furthermore, if a registered user often carries bulky items to place in the trunk, they may set their acceptable combination of actions to include a voice command 150 and a facial gesture 160 or a body gesture 170 that does not involve the arms, such as raising or stomping a foot. Therefore, the user may command the vehicle 110 to open the trunk in a hands-free manner.

According to some embodiments, there may be a universal acceptable combination of actions that applies to every registered user of the vehicle 110. For example, every registered user may be required to nod their head and say “open trunk” as the acceptable combination of actions. The universal acceptable combination of actions may be stored in the trunk actuation command data 460 of every user profile 410, 420, 430 stored in the memory 320.

Alternatively, there may be one or more predetermined acceptable facial gestures 160, one or more predetermined acceptable body gestures 170, and one or more predetermined acceptable voice commands 150 that are universal to all registered users of the vehicle 110. In this case, the acceptable combination of actions can vary such that any combination of two or more of approaching the vehicle 180, performing at least one of the one or more predetermined facial gestures 160, performing at least one of the one or more predetermined body gestures 170, or performing at least one of the one or more predetermined voice commands 150 can constitute the acceptable combination. The one or more predetermined acceptable facial gestures 160, one or more predetermined acceptable body gestures 170, and one or more predetermined acceptable voice commands 150 that are universal to all registered users of the vehicle 110 may be stored in the trunk actuation command data 460 of every user profile 410, 420, 430 stored in the memory 320.

For instance, when a person 140 that is a registered user is approaching the vehicle 180 and performing one or more of the universal predetermined acceptable body gestures 170, the controller 210 determines that the registered user performs an acceptable combination of actions. For example, the predetermined body gestures 170 may include waving a hand and stomping a foot three times. The predetermined facial gestures 160 may include raising the eyebrows twice and turning the head to the left side. The predetermined voice command 150 may be “open trunk.” Therefore, if the controller determines that the person 140 approaches the vehicle 180 and performs at least one of waving a hand, stomping a foot three times, raising the eyebrows twice, turning the head to the left side, or saying “open trunk,” the controller 210 determines that the person 140 performs an acceptable combination of actions. Alternatively, if the person 140 waves a hand and performs at least one of approaching the vehicle, raising the eyebrows twice, turning the head to the left side, or saying “open trunk,” the controller 210 determines that the person 140 performs an acceptable combination of actions.

Requiring a person 140 to perform at least two predetermined actions from different action categories in order to trigger the vehicle 110 to open the trunk door 120 increases the security of the vehicle 110. In particular, it reduces the likelihood of accidentally opening the trunk door 120 when the person 140 does not intend for the trunk door 120 to be opened. As such, the user is not inconvenienced by having to close the trunk door 120 if it is unintentionally opened. Furthermore, the likelihood of the trunk door 120 being left open for long periods of time if the user does not notice that the trunk door 120 has been unintentionally automatically opened is reduced. Therefore, the security of the vehicle 110 is enhanced.

When the controller 210 determines that the person 140 has performed an acceptable combination of actions, the controller 210 sends a signal to the trunk door actuator 270 to open the trunk door 120. (550) The trunk door actuator 270 then operates to open the trunk door 120.

If the controller 210 determines that the person 140 fails to perform the acceptable combination of actions, the operation 500 returns to collect sensor data from the plurality of sensors. (505) The controller 210 may control the plurality of sensors to track the facial and/or body landmarks of the person 140 for a predetermined amount of time before determining that the person 140 does not perform the acceptable combination of actions.

### Methods of Identifying a Registered User

FIG. 6 is a flow chart of an operation 515 of identifying a registered user according to disclosed embodiments.

As shown in FIG. 6, the operation 515 begins with gathering image data from the data collected by the plurality of sensors. (610) The controller 210 gathers image data such as data collected by the one or more camera sensors 220 from the collected data.

Subsequently, the controller 210 compares the gathered image data with stored image data included in user profiles 410, 420, 430. (620) The user profiles 410, 420, 430 are stored in the memory 320. In particular, the user profiles 410, 420, 430 may each include facial data 440 of the associated registered user. The facial data 440 of the registered user may include image data comprising one or more images of the registered user's face.

Based on the comparison of the gathered image data and the user profiles 410, 420, 430, the controller 210 determines whether the gathered image data contains the face of any of the registered users whose associated user profiles 410, 420, 430 are stored in the memory 320. (630) If the gathered image data contains a face of any of the registered users of the vehicle 110, the controller 210 determines that the gathered image data includes the face of the registered user. (640) Alternatively, if the gathered image data does not match a face of any of the registered users, the controller determines that the gathered image data does not include a face of a registered user. (650).

### Method of Determining Whether a Voice Command Is Received

FIG. 7 is a flow chart of an operation 530 of determining whether a voice command 150 has been received according to disclosed embodiments.

As shown in FIG. 7, this operation 530 begins with gathering voice data from the data collected by the plurality of sensors in step 505 of operation 500. (710) The controller 210 gathers audio data collected by the one or more microphone sensors 230 from the collected data. The controller 210 processes the audio data to determine whether it contains data of a voice of a person 140. The controller 210 further gathers the audio data that includes the voice of the person 140.

The controller 210 compares the gathered data including the voice of the person 140 with data from user profiles 410, 420, 430 of registered users of the vehicle 110 that are stored in the memory 320. In particular, the controller compares the gathered voice data with the voice data 450 that may be stored in each user profile 410, 420, 430. (720)

Based on the comparison of the gathered voice data with the voice data 450 stored in the user profiles 410, 420, 430 of the registered users of the vehicle 110, the controller 210 determines whether the voice of the person 140 matches a voice of a registered user. (730) If the data indicating the voice of the person 140 matches voice data 450 of one of the registered users, the controller 210 determines that the person 140 is the registered user.

If the controller 210 determines that the voice of the person 140 matches a voice of a registered user, the controller 210 analyzes the voice data to determine what words the person 140 has said or what sounds the person 140 has made. (740)

Based on the analysis of the gathered voice data, the controller 210 determines whether a voice command to open the trunk has been received. The controller may compare the analyzed voice data to predetermined voice commands 150 to determine whether the analyzed data contains a predetermined voice command 150. Based on this comparison, the controller 210 determines whether a voice command 150 to open the trunk has been received. (750)

If the controller 210 determines that the analyzed voice data contains a predetermined voice command 150, the controller 210 determines that a voice command 150 to open the trunk has been received. (760) If the controller 210 determines that the gathered voice data does not match voice data of a registered user, or if the analyzed voice data does not indicate that the person 140 has performed a predetermined voice command 150, the controller 210 determines that a voice command 150 to open the trunk has not been received. (770)

### Method of Determining Whether a Facial Gesture Command Is Received

FIG. 8 is a flow chart of an operation 535 for determining whether a person 140 has made a command with head or facial movements 160 according to disclosed embodiments.

As shown in FIG. 8, the operation 535 begins with gathering image data from the data collected by the plurality of sensors. (810) The controller 210 gathers image data collected by the one or more camera sensors 220 from the collected data.

The controller 210 further processes the image data to identify a head and/or face of the person 140 captured in the image data. The controller 210 may further identify at least one facial landmark of the person 140 from the collected image data. The at least one facial landmark may include, for example, a nose of the person 140, an eye of the person 140, lips of the person 140, or an eyebrow of the person 140.

Subsequently, the controller 210 compares the gathered image data with stored data from user profiles 410, 420, 430. (820) In particular, the controller 210 compares the gathered image data with trunk actuation command data 460 stored in the user profile 410, 420, 430 associated with the person 140. The trunk actuation command data 460 may include data regarding one or more predetermined facial gestures 160 that comprise an acceptable combination of actions for the registered user to command the vehicle 110 to open the trunk door 120.

The controller 210 compares the processed image data to the predetermined facial gestures 160 indicated by the trunk actuation command data 460 stored in the user profile 410, 420, 430 associated with the person 140 and determines whether the gathered image data indicates that the person 140 performs a predetermined facial gesture 160. (830)

If the gathered image data indicates that the person 140 performs a facial gesture 160 that matches at least one of the predetermined facial gestures 160 stored in the user profile 410, 420, 430 associated with the person 140, the controller 210 determines that the person 140 makes a facial gesture command 160. (840) If the gathered image data does not match at least one of the predetermined facial gestures 160 stored in the user profile 410, 420, 430 associated with the person 140, the controller 210 determines that the person 140 does not make a facial gesture command 160. (850)

### Method of Determining Whether a Body Gesture Command Is Received

FIG. 9 is a flow chart of an operation 540 for determining whether a person 140 has made a command with body gestures 170 according to disclosed embodiments.

As shown in FIG. 9, the operation 540 begins with gathering image data from the data collected by the plurality of sensors. (910) The controller 210 gathers image data such as data collected by the one or more camera sensors 220 from the collected data.

The controller 210 further processes the image data to identify a body of the person 140 captured in the image data. The controller 210 may further identify at least one body landmark of the person 140 from the collected image data. The at least one body landmark may include a hand of the person 140, a foot of the person 140, a knee of the person 140, an elbow of the person 140, a head of the person 140, or an abdomen of the person 140.

Subsequently, the controller 210 compares the gathered image data with stored data from user profiles 410, 420, 430. (920) In particular, the controller 210 compares the gathered image data with trunk actuation command data 460 stored in the user profile 410, 420, 430 of the person 140 who is a registered user of the vehicle 110. The trunk actuation command data 460 may include data regarding one or more predetermined body gestures 170 that comprise an acceptable combination of actions for the person 140 to command the vehicle 110 to open the trunk door 120.

The controller 210 compares the processed image data to the predetermined body gestures 170 indicated by the trunk actuation command data 460 stored in the user profile 410, 420, 430 associated with the person 140. Based on the comparison, the controller 210 determines whether the gathered image data indicates that the person 140 performs a predetermined body gesture 170. (930)

If the gathered image data indicates that the person 140 performs a body gesture 170 that matches at least one of the predetermined body gestures 170 stored in the user profile 410, 420, 430 associated with the person 140, the controller 210 determines that the person 140 makes a body gesture command 170. (940) If the gathered image data does not match at least one of the predetermined body gestures 170 stored in the user profile 410, 420, 430 of the registered user of the vehicle 110, the controller 210 determines that the person 140 does not make a body gesture command 170. (950)

### Operation of a Vehicle System According to an Alternate Embodiment

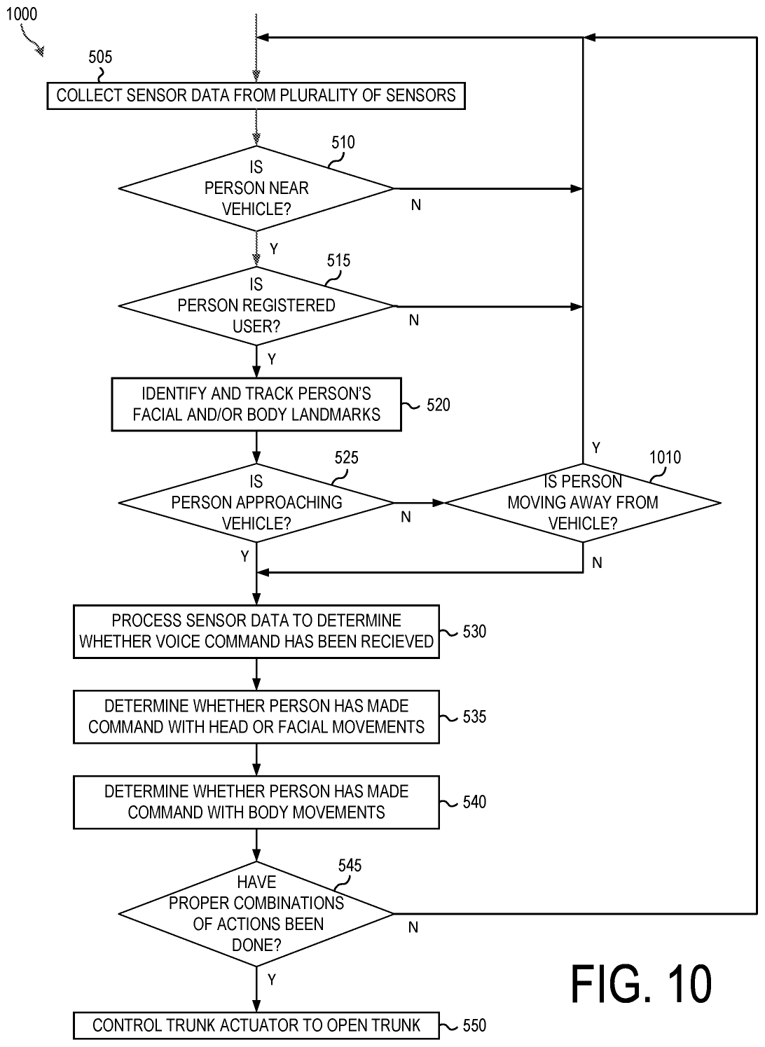

FIG. 10 is a flow chart of an operation 1000 of a vehicle trunk actuation system according to an alternate embodiment.

The steps 505 to 525 of the operation 1000 shown in FIG. 10 are substantially the same as steps 505 to 525 shown in FIG. 5. Therefore, description of these steps will not be repeated here.

In the operation 1000, if the controller 210 determines in step 525 that the person 140 is not approaching the vehicle 110, the controller 210 further determines whether the person 140 is moving away from the vehicle. (1010) For example, the controller 210 may analyze data from at least one of the one or more camera sensors 220, the one or more sonar sensors 240, the one or more radar sensors 250, or the one or more LiDAR sensors 260 to determine if the person 140 is moving further away from the vehicle 110. The controller 210 may analyze data from the one or more microphone sensors 230 to determine whether the audio data indicates that the person 140 is moving further away from the vehicle 110.

If the controller 210 determines that the person 140 is moving away from the vehicle 110, it is assumed that the person 140 does not want to open the trunk, and the operation 1000 returns to collect sensor data from the plurality of sensors. (505) This prevents the trunk door 120 from being opened when the person 140 does not intend to open the trunk door 120, enhancing the security of the vehicle 110.

However, if the controller 210 determines that the person 140 is not moving away from the vehicle 110, the operation 1000 proceeds to step 530 to determine whether a voice command 150 has been received.

Therefore, in the present embodiment, even if a person 140 is standing substantially stationary near the vehicle 110 or if the person 140 is moving in a path that does not bring them either closer to the vehicle 110 or further from the vehicle 110, the person 140 may still perform an acceptable combination of actions to command the vehicle 110 to open the trunk door 120. This increases the convenience of opening the trunk door 120 for the person 140. For example, the person 140 may wish to stand still to gather or organize their belongings before opening and loading the trunk. The person 140 may then command the vehicle 110 to open the trunk door 120 automatically even if they are standing still.

Steps 530 to 550 of operation 1000 are substantially the same as steps 530 to 550 of operation 500. Therefore, description of steps 530 to 550 of operation 1000 is omitted here.

### CONCLUSION

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

1. A method for opening a trunk of a vehicle comprising:
receiving sensor data from at least one of a plurality of sensors mounted on the vehicle;
determining that a person is present within a predetermined distance of the vehicle based on the sensor data;
responsive to determining that the person is present within the predetermined distance of the vehicle, determining that the person is a registered user of the vehicle based on the sensor data and stored user data;
responsive to determining that the person is the registered user of the vehicle, determining that the person performs an acceptable combination of actions; and
responsive to determining that the person performs the acceptable combination of actions, controlling a trunk door actuator to open the trunk of the vehicle,
wherein
the acceptable combination of actions includes at least two of the following actions: approaching the vehicle, performing a predetermined facial gesture, performing a predetermined body gesture, and performing a predetermined voice command.

2. The method of claim 1, further comprising:
responsive to determining that the person is the registered user, retrieving a stored user profile associated with the person,
wherein
the stored user profile indicates at least one predetermined combination of actions associated with the person that satisfy the requirement of the acceptable combination of actions.

3. The method of claim 1, wherein
the acceptable combination of actions can vary such that any combination of two or more of approaching the vehicle, performing a predetermined facial gesture, performing a predetermined body gesture, and performing a predetermined voice command can constitute the acceptable combination.

4. The method of claim 1, further comprising:
identifying at least one facial landmark on a face of the person, wherein
determining that the person performs the predetermined combination of actions comprises
tracking the at least one facial landmark; and
identifying whether the at least one facial landmark makes at least one of a predetermined one or more acceptable facial movements.

5. The method of claim 1, further comprising:
identifying at least one body landmark on a body of the person, wherein
determining that the person performs the predetermined combination of actions comprises
tracking the at least one body landmark; and
identifying whether the at least one body landmark makes at least one of a predetermined one or more acceptable body movements.

6. The method of claim 1, further comprising:
responsive to determining that the person is present within the predetermined distance of the vehicle, determining whether the person is approaching the vehicle based on the sensor data.

7. The method of claim 1, wherein the operation of determining that the person is the registered user of the vehicle based on the received data further comprises:
analyzing the sensor data to identify a face of the person,
comparing the identified face of the person to stored image data of the face of the registered user, and
determining that the person is the registered user responsive to the identified face of the person matching the stored image data of the face of the registered user.

8. The method of claim 1, wherein
the received data includes audio data, and
the operation of determining that the person is the registered user of the vehicle based on the received data comprises
analyzing the audio data to identify voice data corresponding to a voice of the person,
comparing the identified voice data to stored voice data corresponding to a voice of the registered user, and
determining that the person is the registered user responsive to the identified voice data matching the stored voice data of the registered user.

9. The method of claim 1, wherein
the operation of determining that a person is present within a predetermined distance of the vehicle based on the received data comprises locating a face of the person,
identifying a distance of the person from the vehicle, and
determining that the distance from the person to the vehicle is within the predetermined distance.

10. The method of claim 1, wherein
the predetermined action includes at least one of performing a predetermined facial gesture, performing a predetermined body gesture, or performing a predetermined voice command.

11. A non-transitory computer-readable medium comprising instructions for execution by a computer, the instructions including a computer-implemented method for mitigating driver distraction in a vehicle, the instructions for implementing:
receiving sensor data from at least one of a plurality of sensors mounted on the vehicle;
determining that a person is present within a predetermined distance of the vehicle based on the sensor data;
responsive to determining that the person is present within the predetermined distance of the vehicle, determining that the person is a registered user of the vehicle based on the sensor data and stored user data;
responsive to determining that the person is the registered user of the vehicle, determining that the person performs an acceptable combination of actions; and
responsive to determining that the person performs the acceptable combination of actions, controlling a trunk door actuator to open the trunk of the vehicle,
wherein
the acceptable combination of actions includes at least two of the following actions: approaching the vehicle, performing a predetermined facial gesture, performing a predetermined body gesture, and performing a predetermined voice command.

12. The non-transitory computer-readable medium, as recited in claim 11, the instructions for further implementing:
identifying at least one facial landmark on a face of the person, wherein
determining that the person performs the predetermined combination of actions comprises
tracking the at least one facial landmark; and
identifying whether the at least one facial landmark makes at least one of a predetermined one or more acceptable facial movements.

13. The non-transitory computer-readable medium, as recited in claim 11, the instructions for further implementing:
identifying at least one body landmark on a body of the person, wherein
determining that the person performs the predetermined combination of actions comprises
tracking the at least one body landmark; and
identifying whether the at least one body landmark makes at least one of a predetermined one or more acceptable body movements.

14. The non-transitory computer-readable medium, as recited in claim 11, the instructions for further implementing:
responsive to determining that the person is present within the predetermined distance of the vehicle, determining whether the person is approaching the vehicle based on the sensor data.

15. The non-transitory computer-readable medium, as recited in claim 11, wherein the received data includes audio data, and
the operation of determining that the person is the registered user of the vehicle based on the received data comprises
analyzing the audio data to identify voice data corresponding to a voice of the person,
comparing the identified voice data to stored voice data corresponding to a voice of the registered user, and
determining that the person is the registered user responsive to the identified voice data matching the stored voice data of the registered user.

16. A computer system configured for controlling an operational mode of an outdoor air-conditioning unit connected to a plurality of indoor air-conditioning units, the plurality of indoor air-conditioning units including a master indoor unit and a plurality of reporting indoor units, the system comprising:
a transceiver operable to transmit and receive communications over at least a portion of a network;
a memory configured to store data and instructions; and
a processor cooperatively operable with the transceiver and the memory, and configured to facilitate:
receiving sensor data from at least one of a plurality of sensors mounted on the vehicle;
determining that a person is present within a predetermined distance of the vehicle based on the sensor data;
responsive to determining that the person is present within the predetermined distance of the vehicle, determining that the person is a registered user of the vehicle based on the sensor data and stored user data;
responsive to determining that the person is the registered user of the vehicle, determining that the person performs an acceptable combination of actions; and
responsive to determining that the person performs the acceptable combination of actions, controlling a trunk door actuator to open the trunk of the vehicle,
wherein
the acceptable combination of actions includes at least two of the following actions: approaching the vehicle, performing a predetermined facial gesture, performing a predetermined body gesture, and performing a predetermined voice command.

17. The computer system of claim 16, wherein the processor is further configured to facilitate:
identifying at least one facial landmark on a face of the person,
wherein
determining that the person performs the predetermined combination of actions comprises
tracking the at least one facial landmark; and
identifying whether the at least one facial landmark makes at least one of a predetermined one or more acceptable facial movements.

18. The computer system of claim 16, wherein the processor is further configured to facilitate:
identifying at least one body landmark on a body of the person,
wherein
determining that the person performs the predetermined combination of actions comprises
tracking the at least one body landmark; and
identifying whether the at least one body landmark makes at least one of a predetermined one or more acceptable body movements.

19. The computer system of claim 16, wherein the processor is further configured to facilitate:
responsive to determining that the person is present within the predetermined distance of the vehicle, determining whether the person is approaching the vehicle based on the sensor data.

20. The computer system of claim 16, wherein
the received data includes audio data, and
the operation of determining that the person is the registered user of the vehicle based on the received data comprises
analyzing the audio data to identify voice data corresponding to a voice of the person,
comparing the identified voice data to stored voice data corresponding to a voice of the registered user, and
determining that the person is the registered user responsive to the identified voice data matching the stored voice data of the registered user.
